(19) United States
(12) Patent Application Publication
(10) Pub. No.: US 2008/0218356 A1
(43) Pub. Date: Sep. 11, 2008

(54) Radio Frequency Identification Objects and Systems Employing the Same

(76) Inventors: Dean L. Frew, McKinney, TX (US); Thomas C. Abraham, Dallas, TX (US)

Correspondence Address: SLATER & MATSIL, L.L.P., 17950 PRESTON RD, SUITE 1000, DALLAS, TX, 75252-5793, US

(21) Appl. No.: 12/032,305

(22) Filed: Feb. 15, 2008

Related U.S. Application Data
(60) Provisional application No. 60/902,140, filed on Feb. 16, 2007.

(51) Int. Cl. G08B 13/22

(52) U.S. Cl. 340/572.8

(57) ABSTRACT

A radio frequency identification (“RFID”) reader, system and object, and methods of operating and manufacturing the same. In one embodiment, the RFID object includes a container having an interior wall, an exterior wall and a cavity therebetween. The RFID object also includes an RFID tag located within the cavity. In another embodiment, the RFID object includes a container having an interior wall and an exterior wall. The RFID object also includes a first RFID tag attached to the interior wall, and a second RFID tag attached to the exterior wall.

This application claims the benefit of U.S. Provisional Application No. 60/902,140, entitled “RFID Tag Attachment Methods,” filed on Feb. 16, 2007, which application is incorporated herein by reference.

### TECHNICAL FIELD

The present invention is directed, in general, to radio frequency identification (“RFID”) systems and, in particular, to an RFID reader, system and object, and methods of operating and manufacturing the same.

### BACKGROUND

While the core technologies that support radio frequency identification (“RFID”) systems have been around for some time, the applications that drive the use thereof have been slow to market. The aforementioned trend has been turning in an impressive fashion as the size and cost of RFID tags has decreased and the sensitivity of RFID readers has increased. Moreover, the market forces, especially with respect to the supply chain in the retail industry, are pulling the RFID technologies into the mainstream and literally onto the shelves.

The RFID tags are used in several logistics and supply chain applications to track and monitor objects such as products and assets through various points in the supply chain. Certain assets are reusable, and it is common to use RFID tags that serve as permanent “license plates” or unique identifiers. The permanent license plate RFID tags save the asset owners money by not requiring a one-way, disposable RFID tag, but those skilled in the art of logistics and transportation understand that this is not limited to only permanent RFID tags on assets. It would be beneficial to implement a system applicable with permanent RFID license plates, one-way RFID tags, or both where the situation applies.

While permanent license plate tags offer some cost advantages, they can be difficult to attach to certain assets as the assets are made of several different materials (e.g., metals, plastics, paper or corrugate fiber (cardboard), and other materials). Permanent RFID tags may also suffer physical and mechanical stresses and abuses during the many uses or “turns” during the asset life cycle.

What is needed is a new and innovative way to attach or embed RFID tags to or on objects while protecting the RFID tag from damage that can occur during normal shipment and logistics practices.

### SUMMARY OF THE INVENTION

These and other problems are generally solved or circumvented, and technical advantages are generally achieved, by advantageous embodiments of the present invention that include a radio frequency identification (RFID) reader, system and object, and methods of operating and manufacturing the same. In one embodiment, the RFID object includes a container having an interior wall, an exterior wall and a cavity therebetween. The RFID object also includes an RFID tag located within the cavity. In another embodiment, the RFID object includes a container having an interior wall and an exterior wall. The RFID object also includes a first RFID tag attached to the interior wall, and a second RFID tag attached to the exterior wall.

In yet another embodiment, an RFID system includes an RFID object and a reader. The RFID object includes a container having an interior wall and an exterior wall and a cavity therebetween. The RFID object also includes a first RFID tag attached to one of the interior wall and the exterior wall, and a second RFID tag located within the cavity. The reader is configured to read at least one of the first RFID tag and the second RFID tag.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a system level diagram of an embodiment of an RFID system constructed according to the principles of the present invention;

FIG. 2 illustrates a block diagram of an embodiment of an RFID tag constructed according to the principles of the present invention;

FIGS. 3 to 6 illustrate diagrams demonstrating exemplary principles of RFID systems in accordance with the principles of the present invention;

FIG. 7 illustrates a block diagram of an embodiment of an RFID reader in communication with an RFID tag according to the principles of the present invention;

FIG. 8 illustrates a diagram of an RFID object constructed according to the principles of the present invention; and

FIGS. 9 and 10 illustrate diagrams of an embodiment of an RFID tag and RFID object, respectively, constructed according to the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. Unless otherwise provided, like designators for devices employed in different embodiments illustrated and described herein do not necessarily mean that the similarly designated devices are constructed in the same manner or operate in the same way. The present invention will be described with respect to an exemplary embodiment in a specific context, namely, an RFID system including subsystems that address placing and locating RFID tags on objects such as products and assets. While the exemplary embodiments are described with respect to an RFID system that places and located RFID tags on selected objects, those skilled in the art should understand that the principles of the present invention are applicable to any application for the RFID system.

With the vast variety of assets used in logistics and transportation, there are several materials upon which RFID tags may be attached or embedded. Not only may the asset materials provide challenges for attachment or embedment, they can also negatively impact RFID read performance post-attachment/post-embedment.

The RFID tagging of the assets is a relatively new application of RFID technology, so there is a need to tag existing assets in circulation as well as newly manufactured assets, potentially inline with the manufacturing process. As the assets suffer abuse due to handling, transportation, and/or the operating environment, there could also be a need to tag the assets in such a way that the RFID tag is protected. The RFID tag could be encapsulated prior to being attached to the object.

The RFID system as described herein provides a method for solving the tag attachment or embedment options. The options may include mechanical attachment such as screws and/or rivets, adhesion methods, or embedment options wherein the RFID tag is actually placed inside the asset during the original manufacturing process or during a post manufacturing process. Those skilled in the art should understand that these methods are different to protect the function of the asset as well as the RFID tag, which is not available for labels such as human readable or barcode labels.

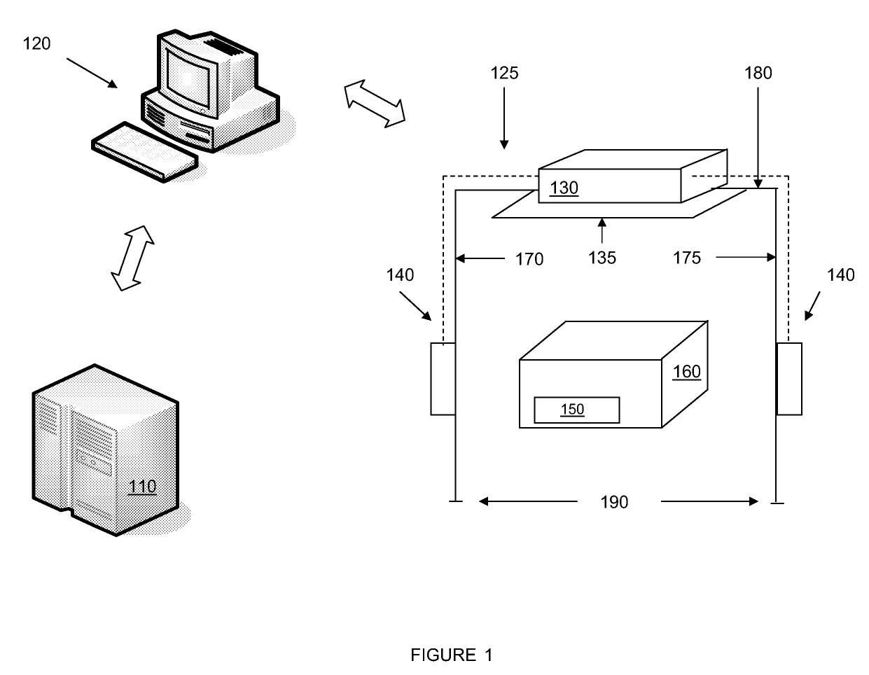

Referring initially to FIG. 1, illustrated is a system level diagram of an embodiment of an RFID system constructed according to the principles of the present invention. The RFID system includes a server 110, a computer system 120, and an RFID portal 125 including an RFID reader 130 located on a plate (e.g., an overhead plate) 135 with antennas (designated 140). The computer system 120 (in connection with the server 110) directs the RFID reader 130 to read RFID tag(s) 150 located on an object such as a product, asset or host material 160. The RFID portal 125 includes first and second vertical stanchions 170, 175 formed from telescopic segments configured to adjust a height thereof. The RFID portal 125 also includes a horizontal stanchion 180 formed from telescopic segments to form an adjustable horizontal crossbar between the first and second vertical stanchions 170, 175. Each of the vertical stanchions 170, 175 includes mount plate footings 190 at a base thereof.

While a single product 160 is illustrated herein, those skilled in the art should understand that the product conceptually may also represent multiple products. In addition, the communication links between respective systems in the RFID system may be wired or wireless communication paths to facilitate the transmission of information therebetween. For a better understanding of communication theory, see the following references “Introduction to Spread Spectrum Communications,” by Roger L. Peterson, et al., Prentice Hall, Inc. (1995), “Modern Communications and Spread Spectrum,” by George R. Cooper, et al., McGraw-Hill Books, Inc. (1986), “An Introduction to Statistical Communication Theory,” by John B. Thomas, published by John Wiley & Sons, Ltd. (1995), “Wireless Communications, Principles and Practice,” by Theodore S. Rappaport, published by Prentice Hall, Inc. (1996), “The Comprehensive Guide to Wireless Technologies,” by Lawrence Harte, et al., published by APDG Publishing (1998), “Introduction to Wireless Local Loop,” by William Webb, published by Artech Home Publishers (1998), and “The Mobile Communications Handbook,” by Jerry D. Gibson, published by CRC Press in cooperation with IEEE Press (1996), all of which are incorporated herein by reference.

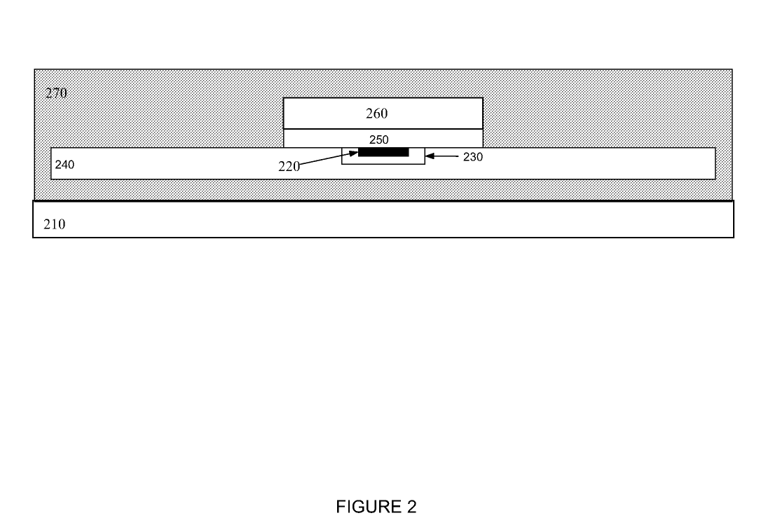

Turning now to FIG. 2, illustrated is a block diagram of an embodiment of an RFID tag constructed according to the principles of the present invention. The RFID tag is affixed or applied to a host material (e.g., a host material including a metal surface or a metal object) 210 and includes an integrated circuit 220 (including memory and a processor) located or embodied in a carrier 230 coupled to an antenna 240. An adhesive 250 is coupled to (e.g., located above and proximate) the carrier 230 and a strain relief member 260 is located above and proximate (e.g., bonded) to the adhesive 250. More particularly, the strain relief member 260 is coupled to the adhesive 250 on a surface opposite the integrated circuit 220 and the carrier 230. In the illustrated embodiment, the adhesive 250 and the strain relief member 260 cover a surface area of the integrated circuit 220 and the carrier 230. The strain relief member 260 provides strain relief for the integrated circuit 220 when the RFID tag is subject to mechanical stress such as compressive or expansive forces. Additionally, the strain relief member 260 may be formed from a temperature resistive material (e.g., a heat resistive material). The RFID tag is encapsulated by an encapsulant 270, which is coupled to and provides an offset for the RFID tag in relation to the host material 210.

As an example, consider the use of ultra high frequency (“UHF”) RFID readers and tags, which typically have an approximate read range of 5 to 10 meters. Of course, the broad scope of the present invention contemplates all types of radio frequency tags as well as general improvements in RFID tag design and detection. All of the different RFID readers may have different read ranges (lobe sizes), but the RFID system described herein may be applied to any type of RFID reader and tag.

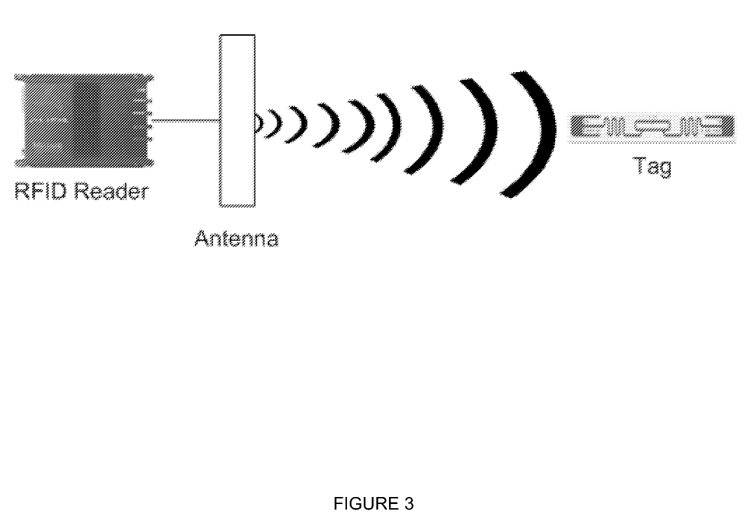

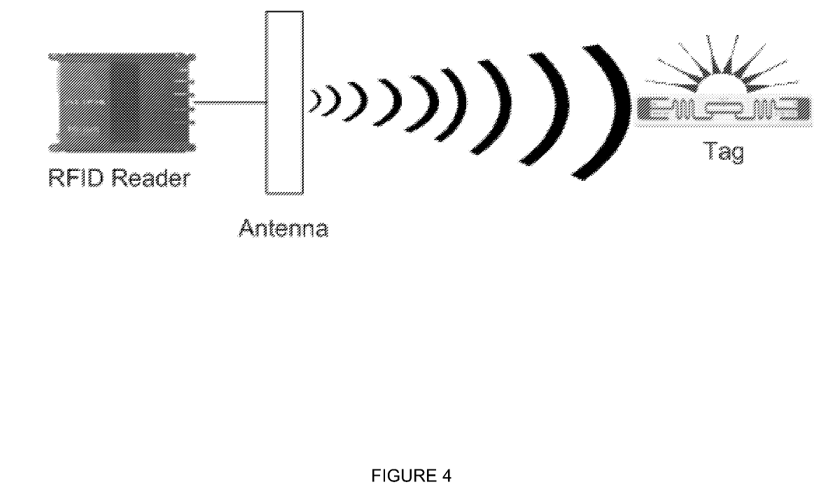

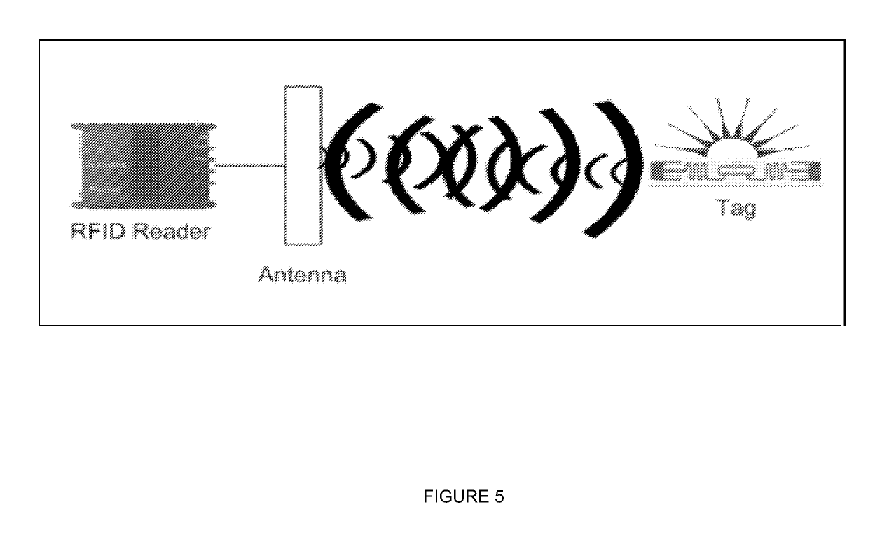

Turning now to FIGS. 3 to 6, illustrated are diagrams demonstrating exemplary principles of RFID systems in accordance with the principles of the present invention. The basic principle of RFID readers and tags is detecting a signal that is transmitted by an active RFID tag, or returned or reflected by a semi-active or passive RFID tag. When the RFID tag “response” occurs in the lobe of an RFID reader, the RFID tag is said to have been “read” by the reader. Oftentimes, the RFID reader may initiate or interrogate the lobe by transmitting a carrier signal to “see” if there are RFID tags present (via the RFID tag responses). The RFID reader interrogates the lobe for RFID tags (FIG. 3) and the RFID tag modulates the carrier signal from the RFID reader (FIG. 4). The RFID tag then responds by returning the modulated carrier signal (FIG. 5).

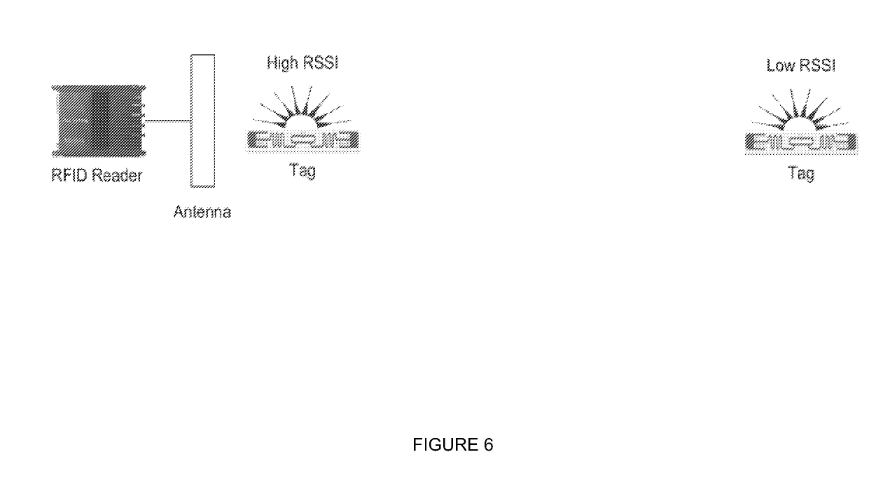

The energy with which the RFID tag responds is finite, and many RFID readers may indicate a delta index such as the received signal strength indication (“RSSI”) in some form or another. This may be displayed as RSSI, reads per second, time differential of arrival (“TDOA”), or any other indication, but all are indices of signal strength or distance indication of the RFID tag from the RFID reader/antenna. The higher the RS SI, the stronger the RFID tag response is, which implies that it is closer to the RFID reader and antenna than a low RSSI value as illustrated in FIG. 6. In TDOA applications, a greater time differential of arrival of the received signal versus the departure of the transmit signal indicates a greater distance between the RFID tag and the RFID reader and antenna.

In the event that the particular RFID reader does not have, for instance, an RSSI indicator/feedback, one can be added to measure the RSSI on behalf of the RFID reader. This does not impact the functionality as described herein as the RSSI can be obtained from an RFID reader or from a readily available RSSI measurement device attached to the RFID reader. The above embodiment described with respect to FIGS. 3 to 6 are examples of passive RFID reader and tag systems, but those skilled in the art comprehend that the same principles apply to active and semi-active RFID systems and are not limited to passive RFID systems.

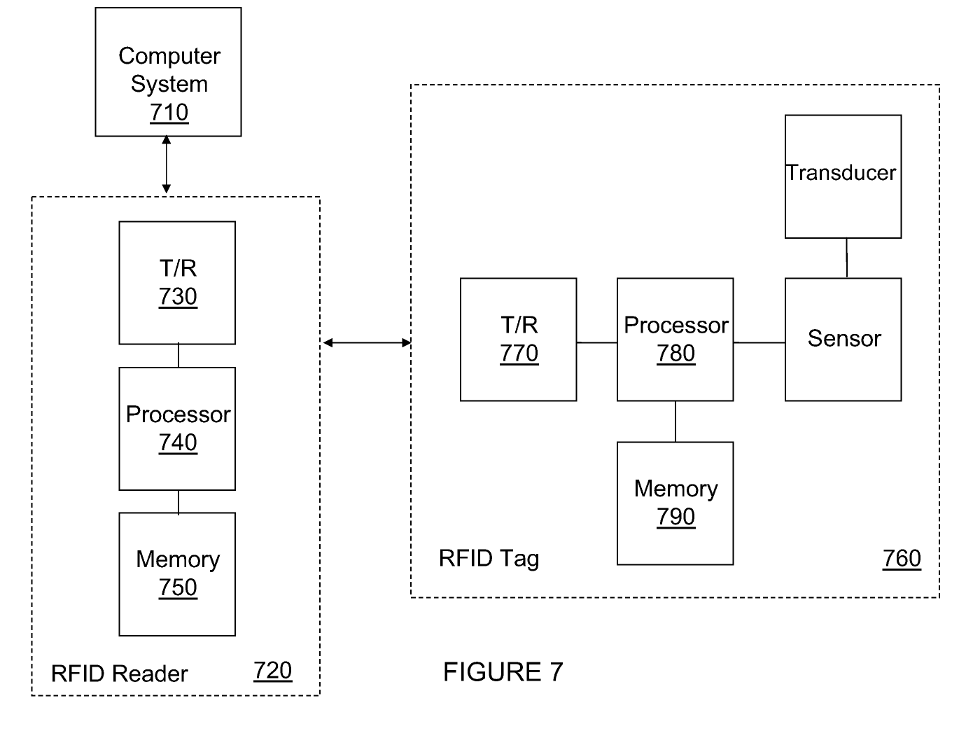

Turning now to FIG. 7, illustrated is a block diagram of an embodiment of an RFID reader in communication with an RFID tag according to the principles of the present invention. A computer system 710 directs the RFID reader 720 to read RFID tag(s) 760 located on an object such as a product. A transmitter/receiver 730 of the RFID reader 720 transmits a carrier signal to the RIFD tag 760 and detects a signal representing the RFID tag 760 from a transmitter/receiver 770 thereof. A processor 740 of the RFID reader 720 processes the signal representing the RFID tag 760 and determines the presence of the RFID tag 760. The processor 740 of the RFID reader 720 can also compare a delta index from the signal to a threshold to determine when the RFID tag 760 is moving. A memory 750 of the RFID reader 720 stores instructions for the processor 740 and results processed thereby. In an analogous fashion, the transmitter/receiver 770 of the RFID tag 760 receives the carrier signal from the RFID reader 720, processes the carrier signal with a processor 780, and provides a signal (e.g., a returned, modulated carrier signal) from the RFID tag 760 via the transmitter/receiver 770 to the RFID reader 720. A memory 790 of the RFID tag 760 stores or includes information such as instructions, RFID tag identification, a parameter profile of the product, and results in the form of processed data and otherwise. While there are many forms of object tagging that may occur under the teachings herein, a few detailed examples are provided herein.

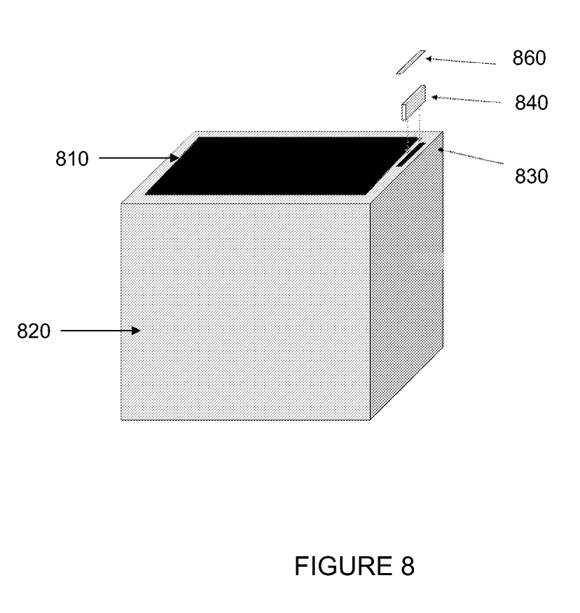

Turning now to FIG. 8, illustrated is a diagram of an embodiment of an RFID object constructed according to the principles of the present invention. The RFID object includes an interior wall 810, an exterior wall 820 and a cavity or slot 830 therebetween, typically created during the molding process. In the illustrated embodiment, an RFID tag 840 is embedded within the RFID object (e.g., attached to an interior wall thereof) for identification. In accordance therewith, an RFID tag 840 is located in the cavity 830 of the RFID object. The RFID object also includes a cap 860 that covers the opening of the cavity 830 after the RFID tag 840 is placed therein.

Some objects have hollow cavities therein that may be leveraged for identification while the object is in its pre-assembly stage or if the cavity 830 is accessible in the RFID object's finished state. The cavities 830 provide a protective encapsulation of the RFID tag 840. Typically, the RFID object as provided herein does not allow for human visibility of the RFID tag 840, unless the RFID object's base material is transparent.

Once the RFID object is completed with assembly, the RFID tag 840 is “embedded” therein. Oftentimes, more than one RFID tag 840 may be used with either a redundant or differing identification to ensure that the RFID object is read via RFID readers throughout the supply chain. This redundancy also enables the use of the RFID object in the event of an RFID tag 840 failure that could occur over the life thereof.

While the RFID tags may be embedded in an object such as an asset, oftentimes, that is not an option. In these instances, the asset identification may be achieved with an RFID tag attached to the exterior or interior of the asset via mechanical or adhesive (or both) mechanisms. For example, some assets do not have a cavity, as their construction is much simpler than the embodiment described above.

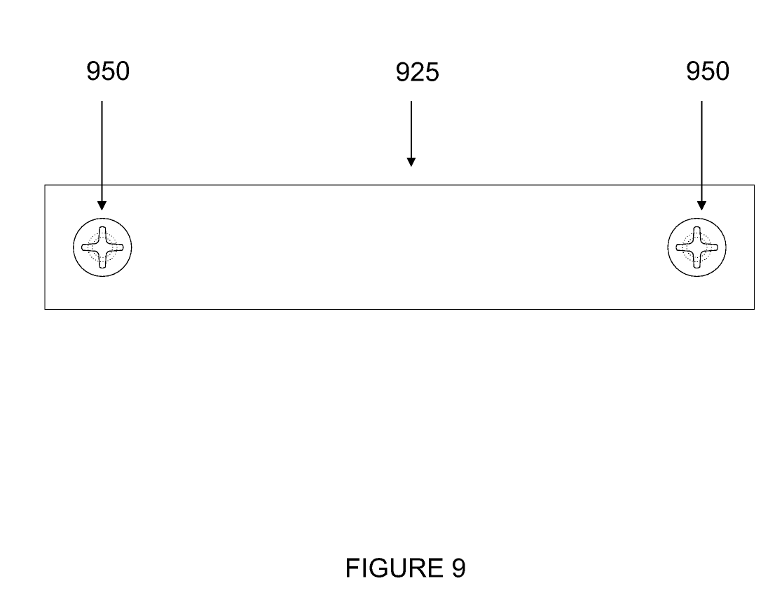

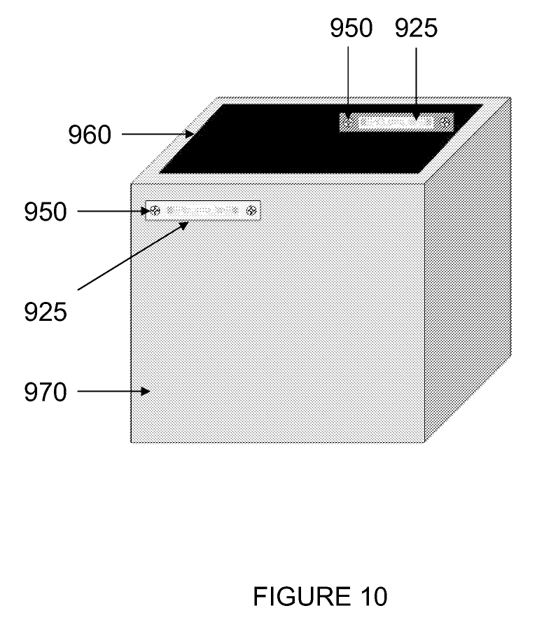

Turning now to FIGS. 9 and 10, illustrated are diagrams of an embodiment of an RFID tag and RFID object, respectively, constructed according to the principles of the present invention. In addition to the components described above with respect to FIG. 2, the RFID tag 925 employs a mechanical mechanism (e.g., screws) 950 to attach the RFID tag 925 to the object. The RFID tags 925 are attached to an interior wall 960 and exterior wall 970 of the RFID object as illustrated in FIG. 10. While the RFID tag 925 includes screws, those skilled in the art understand that the mechanical means could be rivets, adhesives, or even include a cover plate as a shield over the RFID tag 925. This example is provided as an illustration only and does not limit the scope of the system herein.

Thus, an RFID reader, system and object, and methods of operating and manufacturing the same are disclosed herein. In one embodiment, the RFID object includes a container having an interior wall, an exterior wall and a cavity therebetween. The RFID object also includes an RFID tag located within the cavity. In another embodiment, the RFID object includes a container having an interior wall and an exterior wall. The RFID object also includes a first RFID tag attached to the interior wall, and a second RFID tag attached to the exterior wall. In yet another embodiment, an RFID system includes an RFID object and a reader. The RFID object includes a container having an interior wall and an exterior wall and a cavity therebetween. The RFID object also includes a first RFID tag attached to one of the interior wall and the exterior wall, and a second RFID tag located within the cavity. The reader is configured to read at least one of the first RFID tag and the second RFID tag.

For a better understanding of RFID technologies, in general, see “RFID Handbook,” by Klaus Finkenzeller, published by John Wiley & Sons, Ltd., 2nd edition (2003), which is incorporated herein by reference. For a better understanding of RFID tags in compliance with the EPC, see “Technical Report 860 MHz-930 MHz Class I Radio Frequency Identification Tag Radio Frequency & Logical Communication Interface Specification Candidate Recommendation,” Version 1.1, November 2002, promulgated by the Auto-ID Center, Massachusetts Institute of Technology, 77 Massachusetts Avenue, Bldg 3-449, Cambridge, Mass. 02139-4307, which is incorporated herein by reference. For a better understanding of conventional RFID readers, see the following RFID readers, namely, “MP9320 UHF Long-Range Reader,” provided by SAMSys Technologies, Inc. of Ontario, Canada, “MR-1824 Sentinel-Prox Medium Range Reader,” by Applied Wireless ID of Monsey, N.Y. (see also U.S. Pat. No. 5,594,384 entitled “Enhanced Peak Detector,” U.S. Pat. No. 6,377,176 entitled “Metal Compensated Radio Frequency Identification Reader,” U.S. Pat. No. 6,307,517 entitled “Metal Compensated Radio Frequency Identification Reader”), “2100 UAP Reader,” provided by Intermec Technologies Corporation of Everett, Wash. and “ALR-9780 Reader,” provided by Alien Technology Corporation of Morgan Hill, Calif., all of which are incorporated by reference.

Furthermore, for a better understanding of standards base work regarding RFID, see the EPCglobal standards and related publications, namely, EPCglobal release EPC Specification for Class 1 Gen 2 RFID Specification, December 2004, and a “Whitepaper: EPCglobal Class 1 Gen 2 RFID Specification,” published by Alien Technology Corporation, Morgan Hill, Calif. (2005). For a better understanding of RFID devices, see U.S. Pat. No. 6,853,087, entitled “Component and Antennae Assembly in Radio Frequency Identification Devices,” to Neuhaus, et al., issued Feb. 8, 2005. For related applications, see U.S. Patent Application Publication No. 2006/0212141, entitled “Radio Frequency Identification-Detect Ranking System and Method of Operating the Same,” Abraham, Jr., et al., published Sep. 21, 2006, U.S. Patent Application Publication No. 2006/0212164, entitled “Radio Frequency Identification Application System,” to Abraham, Jr., et al., published Sep. 21, 2006, U.S. Patent Application Publication No. 2007/0229284, entitled “Radio Frequency Identification Tag and Method of Forming the Same,” to Svalesen, et al., published Oct. 4, 2007, U.S. patent application Ser. No. 11/876,978, entitled “Asset Including a Radio Frequency Identification Tag and Method of Forming the Same,” to Svalesen, et al., filed Oct. 23, 2007, U.S. patent application Ser. No. 11/949,635, entitled “Radio Frequency Identification Systems,” to Abraham, filed Dec. 3, 2007, U.S. patent application Ser. No. 11/949,640, entitled “Modular Reader Portal,” to Svalesen, filed Dec. 3, 2007, and U.S. patent application Ser. No. 11/949,653, entitled “Radio Frequency Identification Reader and Method of Operating the Same,” to Abraham, filed Dec. 3, 2007. The aforementioned references, and all references herein, are incorporated herein by reference in their entirety.

Also, although the present invention and its advantages have been described in detail, it should be understood that various changes, substitutions and alterations can be made herein without departing from the spirit and scope of the invention as defined by the appended claims. For example, many of the materials and structures discussed above can be implemented in different materials and structures to advantageously form an RFID system as described herein.

Moreover, the scope of the present application is not intended to be limited to the particular embodiments of the process, machine, manufacture, composition of matter, means, methods and steps described in the specification. As one of ordinary skilled in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed:

1. A radio frequency identification (RFID) object, comprising:
a container having an interior wall, an exterior wall and a cavity therebetween; and
an RFID tag located within said cavity.

2. The RFID object as recited in claim 1 further comprising a cap configured to cover said cavity.

3. The RFID object as recited in claim 1 wherein said interior wall and said exterior wall are transparent.

4. The RFID object as recited in claim 1 further comprising another RFID tag located on said exterior wall or said interior wall.

5. The RFID object as recited in claim 1 wherein said RFID tag is attached to an interior wall of said cavity.

6. The RFID object as recited in claim 1 wherein said RFID tag is attached with screws to an interior wall of said cavity.

7. The RFID object as recited in claim 1 wherein said RFID tag includes an integrated circuit located in a carrier coupled to an antenna.

8. A radio frequency identification (RFID) object, comprising:
a container having an interior wall and an exterior wall;
a first RFID tag attached to said interior wall; and
a second RFID tag attached to said exterior wall.

9. The RFID object as recited in claim 8 wherein one of said first RFID tag and said second RFID tag is attached with screws to said interior wall and said exterior wall, respectively.

10. The RFID object as recited in claim 8 wherein one of said first RFID tag and said second RFID tag is attached with an adhesive to said interior wall and said exterior wall, respectively.

11. The RFID object as recited in claim 8 wherein said container includes a cavity between said interior wall and said exterior wall and a third RFID tag is located within said cavity.

12. The RFID object as recited in claim 11 further comprising a cap configured to cover said cavity.

13. The RFID object as recited in claim 11 wherein said third RFID tag is attached to an interior wall of said cavity.

14. The RFID object as recited in claim 8 wherein said first and second RFID tags include an integrated circuit located in a carrier coupled to an antenna.

15. A radio frequency identification (RFID) system, comprising:
an RFID object, including:
a container having an interior wall and an exterior wall, and a cavity therebetween,
a first RFID tag attached to one of said interior wall and said exterior wall, and
a second RFID tag located within said cavity; and
a reader configured to read at least one of said first RFID tag and said second RFID tag.

16. The RFID system as recited in claim 15 wherein said first RFID tag is attached to said interior wall and a third RFID tag is attached to said exterior wall.

17. The RFID system as recited in claim 15 wherein said RFID object includes a cap configured to cover said cavity.

18. The RFID system as recited in claim 15 wherein said interior wall and said exterior wall are transparent.

19. The RFID system as recited in claim 15 wherein said first RFID tag is attached with an adhesive to one of said interior wall and said exterior wall.

20. The RFID system as recited in claim 15 wherein said reader is configured to read at least one of said first RFID tag and said second RFID tag to determine when said RFID object is moving.
